(19) United States
(12) Patent Application Publication
(10) Pub. No.: US 2007/0138814 A1
(43) Pub. Date: Jun. 21, 2007

(54) ADJUSTING DEVICE

(76) Inventors: Martin Frielingsdorf, Werkhausen (DE); Rudolf Wiemer, Windhagen (DE)

Correspondence Address: BROUSE MCDOWELL LPA, 388 SOUTH MAIN STREET, SUITE 500, AKRON, OH, 44311, US

(21) Appl. No.: 11/466,265

(22) Filed: Aug. 22, 2006

(30) Foreign Application Priority Data
Aug. 23, 2005 (DE) 202005013373.6

(51) Int. Cl. E05B 9/00

(52) U.S. Cl. 292/337

(57) ABSTRACT

An adjusting device (1) may include a base (2), a rotary pin (6) rotatably positioned within the base (2), a latch recess (13) formed in the rotary pin (7), a latch body (12), a spring (10); and, a mounting bracket (7) adapted to pivotably hold and position an associated fitting to the rotary pin (6). The spring (10) urges the latch body (12) into the latch recess (13) and thus urges the rotary pin (6) and the associated fitting into a latched condition.

This invention pertains to an adjusting device that holds a pivotable fitting, in particular a fitting for a plate or panel. In particular, the fitting holds and firmly supports a glass plate and a glass door.

Known prior art includes a clamp for use with a glass plate, which is held between two clamping jaws. Such a clamp may be affixed to a wall for example. In another known version, the clamp is recessed in the bead molding of a staircase. In this case, the clamped glass plate is part of a banister. Due to the way this known clamp is anchored, it has the disadvantage of fixing the glass plate into a single position. The installed glass plate cannot be repositioned; in particular, recurrent switching from the original or null position to an adjusted position and back is not possible.

Granted patent EP 0599 255 B1 describes a hinge for doors or windows, in particular for glass swing doors. The hinge comprises two hinge parts which are connected to each other at the hinge axis. The design also provides a latch mechanism consisting of a latch body and latch recess. The latch body is moved in one of the two hinge parts against the force of a spring. The latch recess is aligned with the other part of the hinge. The latch recess is located on the circumference of a rotating body that can be pivoted around the hinge axis. The rotating body can be set using a set screw. The known hinge facilitates setting to a specific lock position, i.e. the start or null position of the hinge. This hinge is particularly suitable for doors or windows. However, especially for the adjustment of simple glass clamps, this prior art technique is too complicated and therefore also too expensive.

The objective of the present invention is therefore to provide a simple, low-cost device to pivotably hold and position a fitting, particularly a clamp for a glass plate.

The inventive adjusting device according to the features of claim 1 meets this objective. Another inventive embodiment of the system is provided in the features of claim 10.

The inventive adjusting device is designed for the pivotable mount and positioning of a fitting, in particular a fitting used to hold a plate or panel, such as a glass plate. The fitting is preferably a clamp for a glass plate. However, the invention is not restricted to use with a clamp. On the contrary, any suitable fitting that holds plates or panels in place can be used. The inventive adjusting device comprises at least one base with at least one rotary pin. (Naturally, the assembly on the base includes the assembly inside the base.) This rotary pin has at least one lock or latch recess. In addition, at least one latch body is mounted within the base and can be moved against the force of an elastic resistive element. (Naturally, the assembly on the base includes the assembly inside the base.) In a locked or latched position, the spring-loaded latch body is positioned within the latch recess. The adjusting device also comprises at least one mounting bracket on the rotary pin for use in mounting to the plate fitting. This mounting bracket and the rotary pin can be manufactured in one piece, or the mounting bracket can be attached to the rotary pin.

The rotary pin of the inventive adjusting device is pivotably mounted to the base. When the latch body is received in the latch recess, the rotary pin is in a defined latch position. The fitting is mounted on the mounting bracket so as to adjust the position of the fitting. The fitting for the glass plate can be placed into a start (or null) position, in particular, by rotating the fitting about the mounting bracket to the desired connection position. The fitting is then fixedly attached to the mounting bracket. This attachment determines the relative positioning of the fitting to the base. When the mounted plate is moved out of its start or null position then accordingly its fitting moves the rotary pin out of its start position. Moving the mounted plate back to its start or null position will automatically also rotate the rotary pin back to its start position in which the latch body is positioned in the latch recess. Thus, the mounted fitting also goes back to its null position.

The advantages of the inventive adjusting device are its simplicity and low-cost production. The design of the adjusting device also makes it possible to install it recessed in a wall, floor or ground, for example.

Preferably, the elastic resistive element is provided by a spring. In particular, the spring may be a coil spring.

In a preferred embodiment of the inventive adjusting device, the latch mechanism comprises at least one pressure element as a seat for one end of the elastic resistive element and at least one adjustment device to push against the other end of the elastic resistive element. Preferably, the pressure element, the elastic resistive element and the adjustment device are assembled inside a guide cylinder formed in the base. The axis of the guide cylinder runs to the axis of the rotary pin. A set screw may be used as the adjustment device that can be turned to adjust the mechanism. In the above-described embodiment or the above-described embodiments, respectively, it is possible to adjust the force which acts upon the latch body and urges it toward the latch recess. Using the adjustment device, the spring is pushed against the pressure element which in turn is pushed against the latch body.

In another embodiment, the pressure element comprises at least one contact area with the latch body. The contact area fits flush against the latch body and is shaped complementary to the shape of the latch body. This facilitates a particularly effective energy transfer.

The rotary pin is preferably secured in a housing formed in the base. The latch body is preferably placed within a notch formed in the base. Preferably, the latch body is in the shape of a cylinder.

The system may comprise at least one inventive adjusting device including at least one of the above-mentioned combinations of characteristic features. Additionally, the inventive system design may include a mounted fitting, particularly a fitting to hold plates or panels. This mounted fitting is attached to the mounting bracket. Preferably, the mounted fitting is selectively attached to the mounting bracket with a screw.

An embodiment of the present invention is now described by means of the following figure:

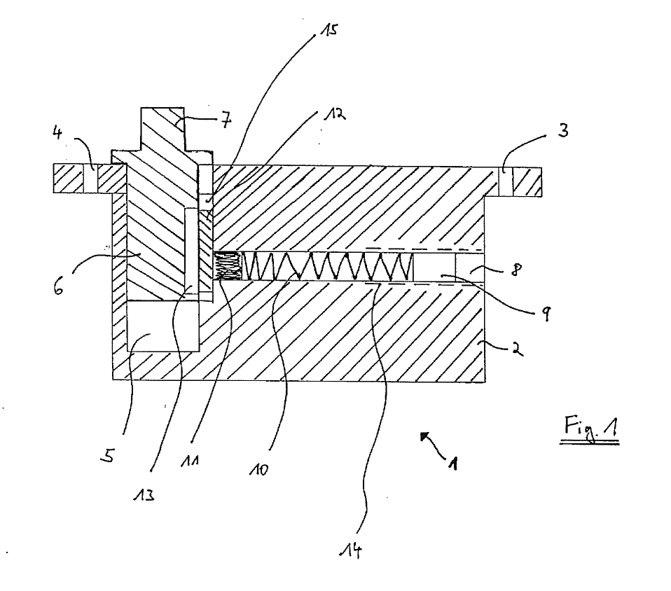

FIG. 1 Show a cross-section of an adjusting device according to the present invention.

FIG. 1 shows an adjusting device 1 for a clamp that can hold a glass plate. The clamp is not shown. The adjusting device 1 comprises a base 2 and is adapted to be positioned within an opening or recess in the floor of a house. A recess for the adjusting device 1 and its base 2 is prepared to anchor the device in the floor. The assembly is then mounted to the floor using screws. The base 2 has two holes 3 and 4 adapted to receive two anchoring screws to install the adjusting device.

The base 2 comprises a rotary pin housing 5, which pivotally supports the rotary pin 6. The mounting bracket 7 and the rotary pin 6 may be formed as one unit. The mounting bracket 7 is designed to hold the clamp. The mounting bracket 7 may be pushed into an inlet hole in the clamp. Using a set screw, the clamp and the mounting bracket 7 are then secured to each other.

The base 2 also has a guide cylinder 8, which traverses the base 2 from one end toward the rotary pin housing 5, and therefore toward the rotary pin 6. The walls of the guide cylinder are at least in part fitted with a thread 14. A set screw 9, a spring 10 and the pressure element 11 are positioned within the guide cylinder 8. With this arrangement, one end of the spring 10 pushes against the set screw 9 and the other end pushes against the pressure element 11. The pressure element 11 in turn contacts a latch body 12 positioned in the base 2 with a contact area. The latch body 12 may be a cylindrical steel pin. The contact area of the pressure element 11 is complementary in shape to the cylindrical shape of the latch body 12 and preferably fits flush against the cylindrical shape of the latch body 12, thus maintaining close contact between the two parts.

The rotary pin 6 has a latch recess 13 on its circumference. When the latch body 12 and latch recess 13 are in proper alignment, the spring force pushes the latch body 12 into the latch recess 13 and secures the rotary pin 6 into the latched position. The force that pushes the latch body 12 into the latch recess 13 can be adjusted using the assembly comprising the set screw 9, the spring 10 and the pressure element 11. The farther the set screw 9 is threaded into the guide cylinder 8, the more force is applied.

As mentioned above, the rotary pin 6 of the inventive adjusting device is arranged in the rotary pin housing 5 and can be rotated in the rotary pin housing 5. The latch body 12 and the latch recess 13 maintain the rotary pin 6 in the latched position. The clamp can be arbitrarily repositioned after loosening the set screw that holds the clamp in place at the mounting bracket 7. Rotating the clamp against the mounting bracket 7 then puts it into the desired null position. The clamp is then again tightly affixed to the mounting bracket 7. This adjusts the positioning of the clamp relative to the base 2. When the clamp holding a glass plate moves out of its null position this movement also turns the rotary pin 6 and adjusts it to the new position. When the glass plate goes back to its null (start) position, so will the rotary pin 6. Based on the relative positions of the latch body 12 and the latch recess 13, the latch mechanism causes the rotary pin 6 to automatically go to the latched position (null position).

### Reference List

1 Adjusting device
2 Base
3 Hole
4 Hole
5 Rotary Pin Housing
6 Rotary Pin
7 Mounting Bracket
8 Guide Cylinder
9 Set Screw
10 Spring
11 Pressure Element
12 Latch Body
13 Latch Recess
14 Thread
15 Latch Fitting

1-11. (canceled)

12. An adjusting device (1) comprising:
a base (2);
a rotary pin (6) rotatably positioned within the base (2);
a latch recess (13) formed in the rotary pin (7);
a latch body (12);
an elastic resistive element (10) adapted to urge the latch body (12) into the latch recess (13); and,
a mounting bracket (7) adapted to hold and position an associated fitting the rotary pin (6).

13. The adjusting device of claim 12 wherein the elastic resistive element is a spring.

14. The adjusting device of claim 12 further comprising:
a pressure element (11) abutting a first end of the elastic resistive element (10) and positioned between the elastic resistive element and the latch body; and,
an adjustment mechanism (9) abutting a second end of the elastic resistive element and adapted to selectively adjust the resistive force of the elastic resistive element.

15. The adjusting device of claim 14 wherein the pressure element (11), the elastic resistive element (10) and the adjustment mechanism (9) are positioned within a guide cylinder (8) formed in the base (2).

16. The adjusting device of claim 15 wherein the guide cylinder has an axis that is substantially perpendicular to an axis of the rotary pin (6).

17. The adjusting device of claim 14 wherein the adjustment mechanism (9) comprises a set screw.

18. The adjusting device of claim 14 wherein the pressure element (11) has a contact area shaped complementary to the outer surface of the latch body (12) to form a flush contact with the latch body.

19. The adjusting device of claim 12 wherein the rotary pin (6) is within a rotary pin housing (5) formed in the base (2).

20. The adjusting device of claim 12 further comprising:
a latch fitting (15) that positions the latch body (12) within the base (2).

21. The adjusting device of claim 12 wherein the latch body (12) is cylindrical in shape.

22. The adjusting device of claim 12 wherein the latch body (12) is placed within a notch formed in the base (2).

23. The adjusting device of claim 22 wherein the notch has an axis that is substantially parallel to an axis of the rotary pin (6).

24. The adjusting device of claim 12 wherein the base (2) has a first hole (3) for use in attaching the adjusting device to an associated structure such as a floor.

25. The adjusting device of claim 15 wherein the guide cylinder has threads 14 that receive the adjustment mechanism (9).

26. A method of latching an adjusting device (1) comprising the steps of:
providing an adjusting device (1) comprising: a base (2); a rotary pin (6) positioned within the base (2) and having a mounting bracket (7) adapted to hold and position an associated fitting; a latch recess (13) formed in the rotary pin (7); a latch body (12); and, an elastic resistive element (10);
rotating the rotary pin (6) to align the latch body (12) with the latch recess (13); and,
urging the latch body (12) into the latch recess (13) with the elastic resistive element (10).

27. The method of claim 26 wherein the step of, urging the latch body (12) into the latch recess (13) with the elastic resistive element (10), comprises the step of:
urging a pressure element (11) positioned between the elastic resistive element (10) and the latch body (12) into contact with the latch body (12).

28. The method of claim 26 wherein prior to the step of, rotating the rotary pin (6) to align the latch body (12) with the latch recess (13), the method comprises the step of:
adjusting the resistive force of the elastic resistive element.

29. The method of claim 28 wherein the step of, adjusting the resistive force of the elastic resistive element, comprises the step of:
adjusting the position of a set screw (9) received within a guide cylinder (8) formed in the base (2).

30. An adjusting device (1) comprising:
a base (2) having a rotary pin housing (5), a guide cylinder (8) and a notch;
a rotary pin (6) having a latch recess (13) and being rotatably positioned within the rotary pin housing (5), the rotary pin (6) having a mounting bracket (7) adapted to hold and position an associated fitting;
a latch body (12) positioned within the notch;
a elastic resistive element (10), a pressure element (11) and an adjustment mechanism (9) all positioned within the guide cylinder (8) such that the elastic resistive element (10) is positioned between the pressure element (11) and the adjustment mechanism; and,
wherein the elastic resistive element (10) urges the pressure element (11) to contact the latch body (12) and urge the latch body (12) into the latch recess (13).

31. The adjusting device (1) of claim 30 wherein:
the guide cylinder has an axis that is substantially perpendicular to an axis of the pin housing (5); and,
the notch has an axis that is substantially parallel to the axis of the pin housing (5).
